(19) United States
(12) Patent Application Publication
(10) Pub. No.: US 2007/0058847 A1
(43) Pub. Date: Mar. 15, 2007

(54) Image Processing Method

(75) Inventors: John Gibbs, Mortsel (BE); Jeroen Cant, Mortsel (BE); Ann Demeyere, Mortsel (BE); Sasha Milicevic, Mortsel (BE)

Correspondence Address: HOUSTON ELISEEVA, 4 MILITIA DRIVE, SUITE 4, LEXINGTON, MA, 02421, US

(73) Assignee: AGFA-GEVAERT N.V., Mortsel (BE)

(21) Appl. No.: 11/470,899

(22) Filed: Sep. 7, 2006

Related U.S. Application Data
(60) Provisional application No. 60/721,812, filed on Sep. 29, 2005.

(30) Foreign Application Priority Data
Sep. 12, 2005 (EP) 05108321.0

(51) Int. Cl. G06K 9/00

(52) U.S. Cl. 382/128

(57) ABSTRACT

A method for processing a medical image represented by a digital image signal and accompanying image identification data wherein upon processing of one of the image and the image identifying data, a corresponding change of the other is effectuated.

### RELATED APPLICATIONS

This application claims priority to European Application No. EP 05108321.0, filed on Sep. 12, 2005, and also claims the benefit of U.S. Provisional Application No. 60/721,812, filed on Sep. 29, 2005, both of which are incorporated herein by reference in their entirety.

### FIELD OF THE INVENTION

The present invention relates to an image processing method and system for use in the field of processing of digital medical images.

### BACKGROUND OF THE INVENTION

Within the context of digital medical imaging techniques, variants can be distinguished: CR (Computed Radiography), DR (Digital Radiography), CT (Computed Tomography), MRI (Magnetic Resonance Imaging) etc. These medical imaging techniques generate a radiation image of a subject or a region of the subject through the use of a so-called ‘image acquisition device’, e.g. a CT scanner, an X-ray modality. The image data acquired by these acquisition devices can then be distributed to other devices, e.g. workstations, archiving stations, display stations etc.

For example in CR (computed radiography) an X-ray image of a body part of a patient is recorded on a recording medium, more particularly on a photostimulable phosphor screen. The photostimulable phosphor screen is conveyed in a cassette.

The cassette carrying the exposed recording medium, e.g. the exposed photostimulable phosphor screen, is then fed into a digitizing apparatus where the recorded image is read out by scanning the screen with stimulating radiation of the appropriate wavelength emitted by a laser and by detecting the image-wise modulated light emitted by the screen upon said stimulation.

This image-wise modulated light is detected by a photoelectric converter and converted into an electric signal representation of the radiation image.

This electric signal representation is then digitized and can then be applied to a workstation on which image processing software is installed and/or to an archiving station that allows storing of the medical image and/or a hard copy recorder that allows medical images to be printed as a hard copy.

Generally the above described devices are interconnected by a network so that image data can be sent directly from one device to another. Alternatively the devices are not interconnected and the data can be imported into one device after being exported from another one.

An image, part of an examination, can be defined by parameters that describe the condition under which the image was taken. Relevant parameters in this context are for example in case of extremities an indication of a left or right extremity (e.g. left fore arm). Another parameter is the view position. This parameter indicates whether the image was acquired from the lateral side of the patient (left or right) or the frontal side (dorsal or ventral).

In the case of a computed radiography image that is recorded on a photostimulable phosphor screen conveyed in a cassette, these parameters are identified and written into a tag for example a radio-frequency tag, provided on the cassette conveying the screen.

In the digitizer these data are read out from the identification tag and associated with the read out image signal representing the image to which they pertain. These data are transferred to peripheral devices (processing unit, display station, archive station, etc.) together with the image signal.

### SUMMARY OF THE INVENTION

It may happen that a cassette has been identified with data regarding an exposure view position which does not correspond with the effectively applied exposure view position. For example in a situation in which a chest PA recording has been planned while at patient arrival a chest AP is recorded on the recording medium, it may happen that the identification tag on the cassette comprises data indicative of a PA recording whereas the recording medium carries a chest PA image.

Image data and associated, erroneous identification data are then transferred to a processing and display system.

In current image processing and display systems, an AP image identified as PA image will be flipped around the vertical axis by a pre-processing algorithm.

Since this does not represent the true situation at image recording, this action might result in an incorrect image interpretation and consequentially also in an incorrect diagnosis.

While in such a case the image may be flipped back to its original status by operator intervention, the data indicative of the view position remain unaffected.

The present invention relates to the medical image data acquired with acquisition devices and to the processing that is applied to these image data.

It is an object of the present invention to provide an image processing method and a corresponding image processing device that does not have the drawbacks of the state of the art.

The above-mentioned advantageous objects are realized by a method and a device as set out in the appended claims.

The invention provides a method for processing a medical image represented by a digital image signal and by accompanying image identification data such as data describing specifications of the exposure or the examination conditions, etc. Upon modification of one of the display of said image and the image identification data, a corresponding change of the other is caused.

The invention further provides a processing and display device comprising means for displaying an image represented by a digital image signal, means for displaying image identification data and means for processing said image. The processing means are arranged to effectuate upon modification of one of the display of said image and the image identifying data, a corresponding change of the other.

Specific features for preferred embodiments of the invention are set out in the dependent claims.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram illustrating the inventive system; and

FIG. 2 is a flow diagram illustrating the inventive method.

### DETAILED DESCRIPTION OF THE PREFERRED EMBODIMENTS

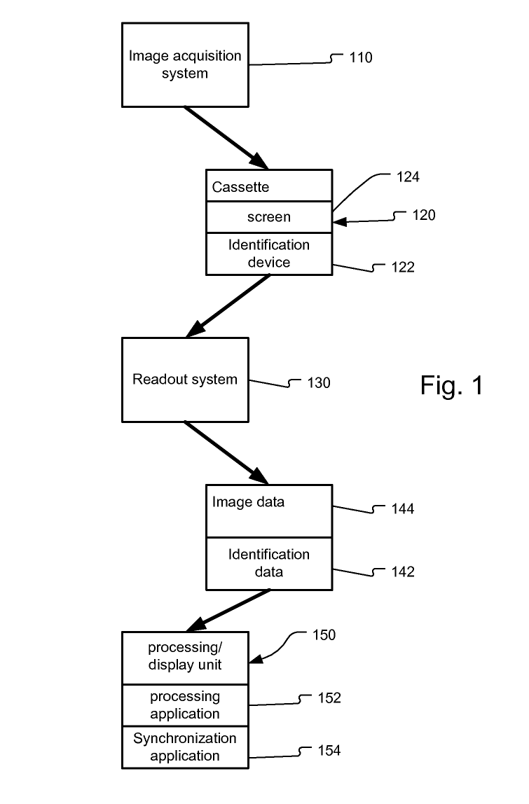

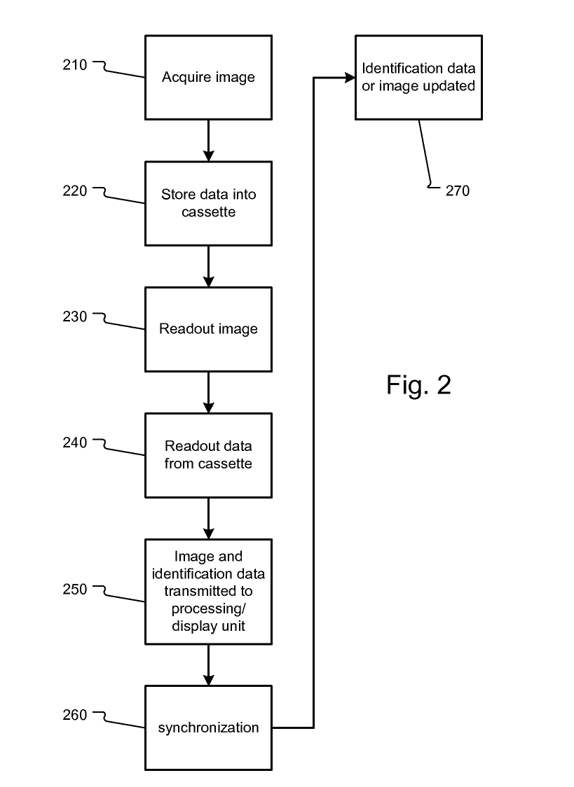

With reference to FIGS. 1 and 2, in an image acquisition phase, a patient is positioned in an image acquisition system 110 such as between an X-ray source and a recording medium. In the described example the recording medium is a photostimulable phosphor screen conveyed in a cassette. Alternative recording media may be envisaged such as photosensitive film, direct x-ray detectors etc.

X-rays emitted by the x-ray source will encounter the patient who is positioned between the source and the cassette conveying the recording medium and, depending on the material the x rays encounter (tissue, bone, skin etc.), the x-rays will penetrate the material differently. The differential penetration of the x-rays will be reflected in the image that is stored in the photostimulable phosphor screen 124 in the cassette 120 in an acquisition step 210.

The cassette is provided with an identification means or system 122, e.g. a radiofrequency tag in which demographic data such as patient identifying data (name, gender, date of birth, pathology history etc.) and data identifying the examination and the examination conditions are written in step 220.

The data regarding the examination conditions describe the details of the image acquisition, e.g. patient facing/not facing X-ray source, landscape or portrait position of cassette during exposure, body part that is examined, etc.

In the described specific embodiment these data are written into the tag in an identification device 122 through radiofrequency transmission.

Alternative identification means 122 requiring other types of communication are also envisaged. An example of another type of device is an EEPROM requiring data communication through galvanic contacts.

Once the image is generated on the photostimulable phosphor screen, the cassette 120 conveying an exposed screen and an identification tag are fed into a so-called digitizer or readout system 130.

There the image data and the data stored in the identification tag are read out in step 230.

For this purpose the photostimulable phosphor screen carrying the radiation image is scanned with stimulating laser light of the appropriate wavelength. Image-wise modulated light emitted by the screen upon stimulation is detected by a photoelectric converter and converted into an electric signal representation of the radiation image. This electric signal representation is digitized.

The data stored in the identification tag are also read out in step 240.

Once the image is read out of the recording medium and the identification data are read out of the identification tag, the image data 142 and associated identification data 144 will be send over a communication line, in the described case over a DICOM connection towards a peripheral device such as a processing and display unit 150 and/or an archive station or the like in step 250.

In order to enable this transmission, digitizer and peripheral station have to be configured so as to be aware of each others presence.

The DICOM protocol is a protocol used on top of a TCP/IP protocol.

Both instances communicate over a DICOM protocol through the TCP/IP protocol. This implies that both instances are configured according to the requirements of these protocols.

For TCP/IP, both instances should have a host name, IP address and subnet mask configured. In order to use the DICOM protocol, both instances should have a so called AE Title configured. When all parameters have been defined for both protocols, communication between the instances is possible.

The data will be transmitted as binary data during a message exchange sequence between both instances. When the data 142, 144 have been transmitted by the digitizer and these data have been received successfully by the image processing station 150, an affirmation will be sent to the digitizer to inform the latter that the data transmission has succeeded.

When the data have been sent to the image processing and display station, the latter will store these data on its local hard disc in a proprietary format. Once the data are present on the local hard disc of the image processing and display station, they are available to the medical image processing software 152 so that modifications can be performed on the image.

Through the graphical user interface of the medical image processing software, the operator can browse through all the available images, i.e. the images that are available on the hard disc. Consequently, he can choose to select a specific image and open it for display. This action will cause the software package 152 to access the data (e.g. examination and/or demographic data) related to the selected image and display the data on a screen.

When an image is selected, all the data related to the image will be retrieved from the hard disc and displayed on screen. Consequently, the operator can modify the data as described above.

Without the provisions of the present invention the image could be manipulated by the operator so that the displayed conditions do not longer match the actual presentation state of the image. Vice versa, the described conditions could also be manipulated through the software package introducing a contradiction relative to the image presentation state. The present invention provides a so-called “synchronization” of both types of information, i.e. the actual image presentation state and the described examination conditions in step 260.

The invention provides that for example when the image is flipped over the vertical axis by the operator, the application will automatically adjust the corresponding parameter within the described examination conditions. By performing this so-called synchronization, there will always be a perfect match between the image presentation state and the examination conditions.

For certain actions, e.g. flipping an image, the software provides that the relevant parameters in the examination description require up-dating. For other actions, e.g. altering the described examination conditions, the software application provides that the image presentation state of the image is to be altered in step 270. A set of applicable rules are thus coded into the software synchronization application 154.

The altered situation is displayed on the screen and/or replaces the former situation in the memory of the image processing and display device.

According to a specific embodiment of the present invention the operator will not indicate the laterality parameter during the image acquisition phase, leaving this parameter empty. During the image processing phase, the operator can add a digital marker to the image to indicate laterality. This digital marker, e.g. a digital left or right indicator, is implemented as a predefined electronic annotation that is placed on the image when it is displayed on the screen. The electronic annotation will be associated with the image and stored as part of the identification data 142.

It will give a visual indication of the lateral side that is at stake. Furthermore, this digital marker serves as a trigger for the software application 152 to deduct all parameters that are related to the laterality. Consequently the application has all relevant parameters available and can start processing the image accordingly.

In still another embodiment of the present invention an automatic flip of an image is provided in case this action is configured on the system level. In contrast to the first aspect of the invention under scope, this automatic flipping will not be reflected in the described examination conditions. This is because this automatic flip is only intended for presentation purposes and thus needs not to be coded in the described examination conditions.

When the synchronization application 154 is confronted with an image for which this automatic flipping was requested (during the configuration phase of the application), it will automatically perform this signal the processing application 154 to perform the flipping around the vertical axis. The image is flipped, without any user interaction.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for processing and displaying a medical image represented by a digital image signal and accompanying image identification data expressing exposure and/or examination conditions,
wherein processing one of a displayed image and accompanying image identifying data, causes a corresponding change of the other.

2. A method according to claim 1 wherein the result of said corresponding change is displayed.

3. A method according to claim 1 wherein the result of said corresponding change is stored in memory.

4. A signal processing and display device comprising
a system for displaying a medical image represented by a digital image signal and for displaying accompanying image identification data expressing exposure and/or examination conditions;
a system for processing said image or said image identification data;
wherein said processing system upon processing one of a displayed image and accompanying image identifying data, effectuates a corresponding change of the other.

5. A device according to claim 4 arranged to display the result of said corresponding change.

6. A device according to claim 4 comprising a memory wherein said corresponding change is stored.

7. A signal processing and display device comprising
means for displaying a medical image represented by a digital image signal and for displaying accompanying image identification data expressing exposure and/or examination conditions,
means for processing said image or said image identification data,
wherein said means for processing are arranged to effectuate upon processing one of a displayed image and accompanying image identifying data, a corresponding change of the other.

8. A computer software product for medical image display system, the product comprising a computer-readable medium in which program instructions are stored, which instructions, when read by a computer, cause the computer to a display a medical image represented by a digital image signal and display accompanying image identification data expressing exposure and/or examination conditions and upon processing one of a displayed image and accompanying image identifying data, effectuate a corresponding change of the other.
